(19) United States
(12) Patent Application Publication
(10) Pub. No.: US 2017/0017097 A1
(43) Pub. Date: Jan. 19, 2017

(54) OPTICAL MODULATOR THAT INCLUDES OPTICAL WAVEGUIDE FORMED IN FERROELECTRIC SUBSTRATE

(71) Applicant: FUJITSU OPTICAL COMPONENTS LIMITED, Kawasaki-shi (JP)

(72) Inventors: Masaharu DOI, Sapporo (JP); Yoshihiko YOSHIDA, Sapporo (JP); Yoshinobu KUBOTA, Yokohama (JP); Yoshitada KAWASHIMA, Sapporo (JP)

(73) Assignee: FUJITSU OPTICAL COMPONENTS LIMITED, Kawasaki-shi (JP)

(21) Appl. No.: 15/279,604

(22) Filed: Sep. 29, 2016

Related U.S. Application Data
(62) Division of application No. 14/946,078, filed on Nov. 19, 2015.

(30) Foreign Application Priority Data
Jan. 29, 2015 (JP) 2015-015940

(51) Int. Cl. G02F 1/00; G02F 1/225

(52) U.S. Cl. CPC G02F 1/0036; G02F 1/225; G02F 2202/22; G02F 2001/212

(57) ABSTRACT

An optical modulator includes: a ferroelectric substrate in which an input optical waveguide, first and second optical waveguides, and an output optical waveguide are formed; a first electrode formed in a vicinity of the first optical waveguide and to which a first DC voltage is applied; a second electrode formed in a vicinity of the second optical waveguide and to which a second DC voltage is applied; a third electrode electrically connected to the first electrode and formed on both sides of the second electrode; and a fourth electrode electrically connected to the second electrode and formed on both sides of the first electrode. A first gap between the first electrode and the fourth electrode is approximately the same as a second gap between the second electrode and the third electrode. A gap between the third electrode and the fourth electrode is 1-5 times greater than the first gap.

### CROSS-REFERENCE TO RELATED APPLICATIONS

This application is a U.S. divisional application filed under 37 CFR 1.53(b) claiming priority benefit of U.S. Ser. No. 14/946,078 filed in the United States on Nov. 19, 2015, which claims earlier priority benefit to Japanese Patent Application No. 2015-015940, filed on Jan. 29, 2015, the entire contents of both of which are incorporated herein by reference.

### FIELD

The embodiments discussed herein are related to an optical modulator that includes an optical waveguide formed in a ferroelectric substrate.

### BACKGROUND

Ferroelectrics that have a strong electro-optic effect are used for optical devices that convert an electric signal into an optical signal. For example, optical modulators that are configured by including a LiNbO3 (lithium niobate) substrate are widely in practical use. The optical modulator that is configured by including a LiNbO3 substrate is sometimes referred to as an LN modulator. Chirping is small in the LN optical modulator and the LN optical modulator can achieve high-speed modulation.

FIGS. 1A and 1B illustrate an example of the configuration of an optical modulator. FIG. 1A is a top view of the optical modulator seen from above. FIG. 1B is a cross-sectional view illustrating an A-A cross section of the optical modulator illustrated in FIG. 1A.

A substrate 1 is a Z-cut LiNbO3 substrate that is formed in the Z-axis direction of a LiNbO3 crystal. An optical waveguide 2 (2a-2d) is formed in the vicinity of the surface of the substrate 1. For example, the optical waveguide 2 is formed by introducing metallic impurities such as Ti in the vicinity of the surface of the substrate 1 and by diffusing the metallic impurities using heat. The optical waveguide 2 includes an input optical waveguide 2a, a pair of straight optical waveguides 2b and 2c, and an output optical waveguide 2d. The straight optical waveguides 2b and 2c are optically coupled to the input optical waveguide 2a. In addition, the straight optical waveguides 2b and 2c are also optically coupled to the output optical waveguide 2d. Note that the straight optical waveguides 2b and 2c are formed substantially parallel to each other. In the following description, from among two surfaces of the substrate 1, a surface in which the optical waveguide 2 is formed may be referred to as a “top surface” or a “mounting surface”. In addition, the other surface of the substrate 1 may be referred to as a “bottom surface”.

On the top surface of the substrate 1, a signal electrode 3 and ground electrodes 4 are formed. The material of the signal electrode 3 and the ground electrode 4 is, for example, gold. In the example illustrated in FIGS. 1A and 1B, the signal electrode 3 is formed in the vicinity of one of the pair of straight optical waveguides 2b and 2c (in the example, the straight optical waveguide 2b). One end of the signal electrode 3 is electrically connected to an electric signal source 11 and the other end of the signal terminal 3 is terminated using a resistor. Note that the electric signal source 11 generates an electric signal that represents transmission data. The ground electrode 4 is formed in an area where the signal electrode 3 is not formed, on the top surface of the substrate 1. In this example, the ground electrode 4 is formed reaching the area above the straight optical waveguide 2c. A buffer layer 5 is formed between the top surface of the substrate 1 and each electrode (the signal electrode 3 and the ground electrodes 4). The buffer layer 5 prevents light transmission from the optical waveguides (2a-2d) to the electrodes (3 and 4). Note that the buffer layer 5 is realized by an insulating film such as a SiO2 film.

In the optical modulator of the above configuration, a continuous wave light that is generated by a laser light source (not illustrated) is input to the input optical waveguide 2a. The input light is branched and is guided to the straight optical waveguides 2b and 2c. The light propagated via the straight optical waveguides 2b and 2c is combined and is output via the output optical waveguide 2d.

Here, when an electric signal is fed to the signal electrode 3, an electric field is generated between the signal electrode 3 and the ground electrode 4 as illustrated in FIG. 1B. Then, due to an electro-optic effect of LiNbO3 that is caused by the electric field, the refractive indexes of the straight optical waveguides 2b and 2c change. That is, a phase difference that corresponds to the electric signal is generated between the light that propagates via the straight optical waveguide 2b and the light that propagates via the straight optical waveguide 2c. Therefore, a modulated optical signal that corresponds to the electric signal is generated.

However, since the substrate 1 is a ferroelectric substrate, a pyroelectric effect is caused due to a change in temperature. Here, in a case in which the substrate 1 is a Z-cut substrate, electric charge is concentrated in an area in the vicinity of the top surface of the substrate 1 and an area in the vicinity of the bottom surface of the substrate 1 as illustrated in FIG. 2. In the example illustrated in FIG. 2, surlpus positive electric charges exist in the area in the vicinity of the top surface of the substrate 1 and surplus negative electric charges exist in the vicinity of the bottom surface of the substrate 1. Furthermore, since surplus positive electric charges exist in the area in the vicinity of the top surface of the substrate 1, surplus negative electric charges exist in areas in the vicinities of the electrodes 3 and 4.

When uneven distribution of electric charge occurs in the substrate 1, the electric field in the substrate 1 is disturbed. Then, when the electric field in the substrate 1 is disturbed, the phase of the light that propagates via the straight optical waveguides 2b and 2c is disturbed. Therefore, a phenomenon in which an optical output curve with respect to an applied voltage is shifted occurs as illustrated in FIG. 3. In the following description, the phenomenon may be referred to as a “temperature drift”. Note that when a temperature drift occurs, the operating point of the optical modulator is shifted from an optimum point. In this case, the quality of a modulated optical signal that is generated by the optical modulator deteriorates.

Note that a technology for reducing uneven distribution of electric charge is proposed (for example, Japanese Laid-open Patent Publication No. 62-73207). In addition, an optical modulator that has the function of adjusting an operating point is known (for example, Japanese Laid-open Patent Publication No. 2003-233042).

The amount of electric charge that is generated due to a pyroelectric effect is proportional to a temperature-change rate. Therefore, when the temperature of the optical modulator rapidly changes, the amount of electric charge that has been accumulated in the substrate 1 and in its vicinity increases. Then, when the amount of electric charge that has been accumulated in the substrate 1 and in its vicinity exceeds an upper limit, the electric charge may be discharged. When the electric charge that has been accumulated in the substrate 1 and in its vicinity is discharged, the phases of the light that propagates via the straight optical waveguides 2b and 2c sharply change because the electric-field distribution of the substrate 1 sharply changes. Therefore, the quality of a modulated optical signal that is generated by the optical modulator deteriorates. Note that a change in the optical phase due to discharge of accumulated electric charge is sometimes referred to as a “phase jump”.

### SUMMARY

According to an aspect of the embodiments, an optical modulator includes: a ferroelectric substrate in which an input optical waveguide, first and second optical waveguides that are optically coupled to the input optical waveguide, and an output optical waveguide that is optically coupled to the first and second optical waveguides are formed; a signal electrode that is formed in a vicinity of at least one of the first optical waveguide and the second optical waveguide; a first electrode that is formed in a vicinity of the first optical waveguide and to which a first DC voltage is applied; a second electrode that is formed in a vicinity of the second optical waveguide and to which a second DC voltage is applied; a third electrode that is electrically connected to the first electrode and formed on both sides of the second electrode; and a fourth electrode that is electrically connected to the second electrode and formed on both sides of the first electrode. A first gap between the first electrode and the fourth electrode is the same or approximately the same as a second gap between the second electrode and the third electrode, and a gap between the third electrode and the fourth electrode is 1-5 times greater than the first gap.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIGS. 1A and 1B illustrates an example of the configuration of an optical modulator.

FIG. 2 is a diagram explaining a pyroelectric effect of a ferroelectric substrate.

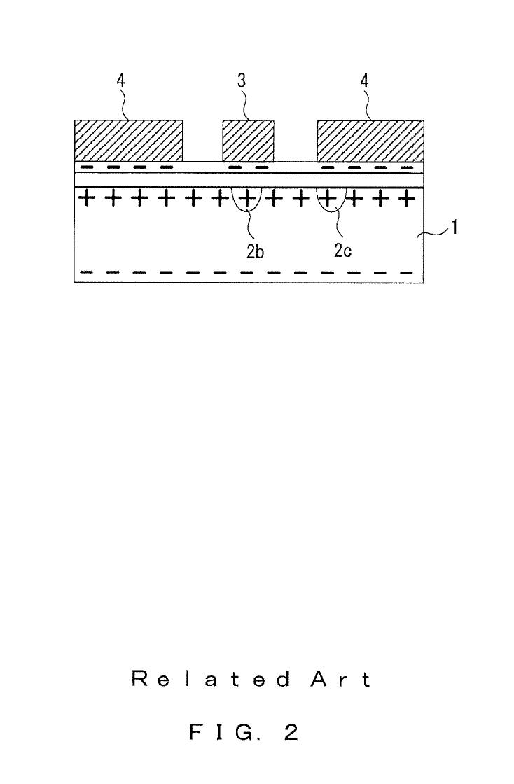

FIG. 3 is a diagram explaining a temperature drift of the optical modulator.

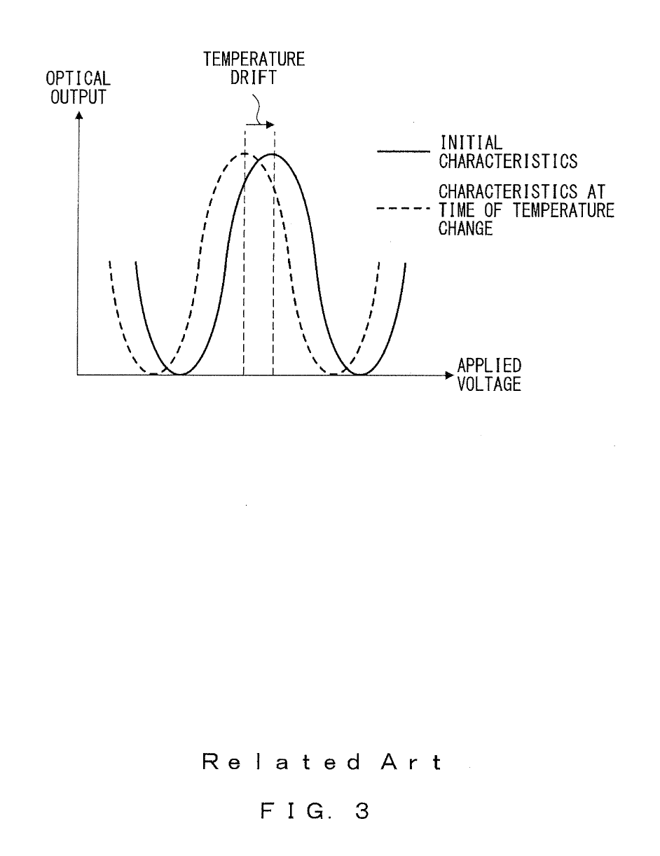

FIG. 4 illustrates an example of an optical transmitter on which the optical modulator is implemented.

FIG. 5 illustrates an example of an optical modulator that has the function of adjusting an operating point.

FIG. 6 is a diagram explaining uneven distribution of electric charge due to a pyroelectric effect.

FIG. 7 illustrates the configuration of an optical modulator according to a first embodiment.

FIG. 8 is a diagram explaining effects of the first embodiment.

FIG. 9 illustrates a modification of the first embodiment.

FIG. 10 illustrates the configuration of an optical modulator according to a second embodiment.

FIG. 11 illustrates a modification of the second embodiment.

FIG. 12 illustrates the configuration of an optical modulator according to a third embodiment.

FIGS. 13A and 13B illustrate an example of an optical modulator equipped with a protective member.

FIGS. 14A and 14B illustrate the configuration of an optical modulator according to a fourth embodiment.

FIGS. 15A and 15B illustrate the configuration of an optical modulator according to a fifth embodiment.

FIG. 16 illustrates the configuration of an optical modulator according to a sixth embodiment.

### DESCRIPTION OF EMBODIMENTS

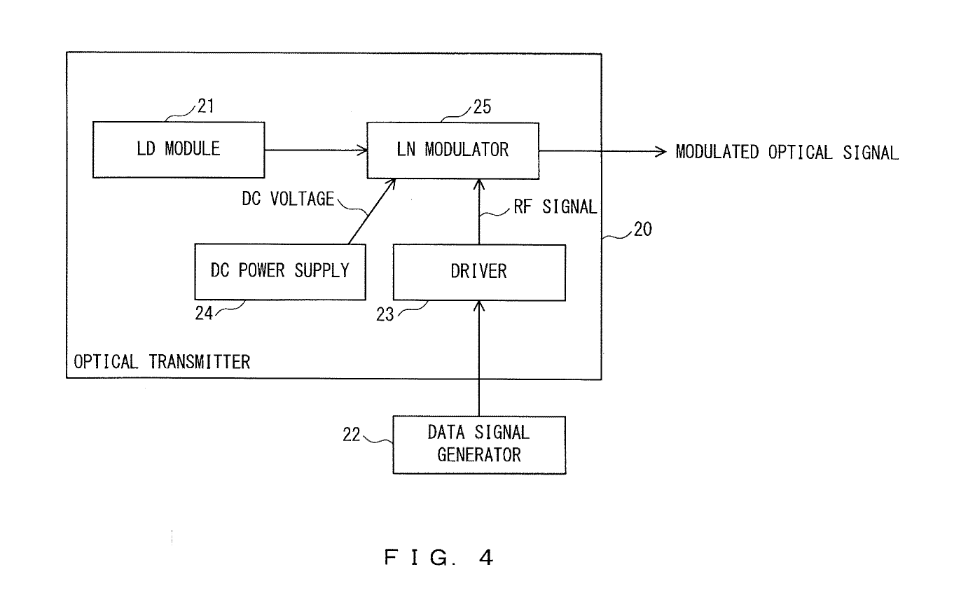

FIG. 4 illustrates an example of the optical transmitter on which an optical modulator according to the embodiments is implemented. As illustrated in FIG. 4, an optical transmitter 20 includes an LD module 21, a driver 23, a DC power supply 24, and an optical modulator 25, and converts an electric signal that is input from a data signal generator 22 into an optical signal.

The LD module 21 generates a continuous wave light of a specified wavelength. The continuous wave light generated by the LD module 21 is guided to the optical modulator 25. The data signal generator 22 generates an electric signal that represents transmission data. Note that the data signal generator 22 may include a mapper that supports a designated modulation format. The driver 23 includes an amplifier and amplifies the electric signal that is generated by the data signal generator 22. The electric signal that is amplified by the driver 23 is fed as an RF signal to a signal electrode of the optical modulator 25. The DC power supply 24 outputs a DC voltage for controlling an operating point of the optical modulator 25. The DC power supply 24 may control the DC voltage so that characteristics of a modulated optical signal that is generated by the optical modulator 25 are optimized. Then, the DC voltage output from the DC power supply 24 is applied to a DC electrode of the optical modulator 25.

The optical modulator 25 modulates using the continuous wave light generated by the LD module 21 with the RF signal that is fed from the driver 23 (that is, the electric signal that is generated by the data signal generator 22), and generates a modulated optical signal. The operating point of the optical modulator 25 is controlled using the DC voltage applied from the DC power supply 24.

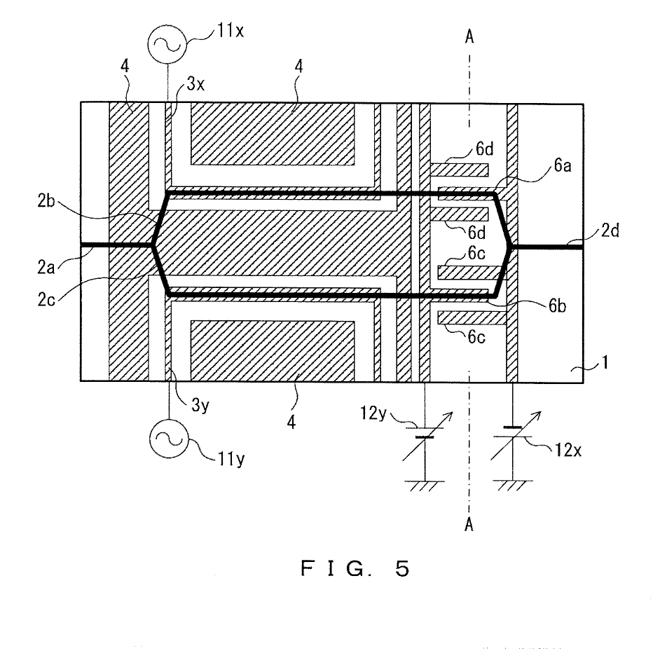

FIG. 5 illustrates an example of the optical modulator that has the function of adjusting the operating point. The operating point of the optical modulator is adjusted by applying a DC voltage to an optical waveguide that is formed in a ferroelectric substrate. Therefore, the optical modulator includes an electrode for applying a DC voltage (hereinafter referred to as a DC electrode).

The substrate 1 is a Z-cut LiNbO3 substrate that is formed in the Z-axis direction of a LiNbO3 crystal. An optical waveguide is formed in the vicinity of the surface of the substrate 1. For example, the optical waveguide is formed by introducing metallic impurities such as Ti in the vicinity of the surface of the substrate 1 and by diffusing the metallic impurities using heat. The optical waveguide includes the input optical waveguide 2a, the pair of straight optical waveguides 2b and 2c, and the output optical waveguide 2d. The straight optical waveguides 2b and 2c are optically coupled to the input optical waveguide 2a. That is, a light that is incident on the input optical waveguide 2a is split and is guided to the straight optical waveguides 2b and 2c. In addition, the straight optical waveguides 2b and 2c are optically coupled also to the output optical waveguide 2d. That is, the light that has been propagated via the straight optical waveguides 2b and 2c is combined and is guided to the output optical waveguide 2d. Note that the straight optical waveguides 2b and 2c are formed substantially parallel to each other.

In the following description, from among two surfaces of the substrate 1, a surface in which the optical waveguides (2a-2d) are formed may be referred to as a “top surface” or a “mounting surface”, and the other surface of the substrate 1 may be referred to as a “bottom surface” or a “back surface”. In addition, the straight optical waveguides 2b and 2c may be referred to as “branched optical waveguides”.

On the top surface of the substrate 1, signal electrodes 3x and 3y and the ground electrodes 4 are formed. The material of the signal electrodes 3x and 3y and the ground electrode 4 is, for example, gold. The signal electrode 3x is formed in the vicinity of the straight optical waveguide 2b. One end of the signal electrode 3x is electrically connected to an electric signal source 11x and the other end of the signal terminal 3x is terminated. Similarly, the signal electrode 3y is formed in the vicinity of the straight optical waveguide 2c. One end of the signal electrode 3y is electrically connected to an electric signal source 11y and the other end of the signal terminal 3y is terminated. That is, electric signals that are output from the electric signal sources 11x and 11y are fed to the signal electrodes 3x and 3y, respectively. Note that the electric signal sources 11x and 11y correspond to the data signal generator 22 and/or the driver 23 illustrated in FIG. 4. In addition, in this example, the electric signal that is generated by the electric signal source 11y is an inverted signal of the electric signal that is generated by the electric signal source 11x.

On the top surface of the substrate 1, the ground electrodes 4 are formed around the signal electrodes 3x and 3y. In addition, on the top surface of the substrate 1, DC electrodes for applying a DC voltage are formed on the output end side with respect to the signal electrodes 3x and 3y.

A DC electrode 6a is formed in the vicinity of the straight optical waveguide 2b. In addition, the DC electrode 6a is electrically connected to a DC power supply 12x. That is, a DC voltage output from the DC power supply 12x is applied to the DC electrode 6a. Similarly, a DC electrode 6b is formed in the vicinity of the straight optical waveguide 2c. In addition, the DC electrode 6b is electrically connected to a DC power supply 12y. That is, a DC voltage output from the DC power supply 12y is applied to the DC electrode 6b.

The DC power supplies 12x and 12y correspond to the DC power supply 24 illustrated in FIG. 4. Output voltages of the DC power supplies 12x and 12y are respectively controlled by means of a controller (not illustrated) so that characteristics of a modulated optical signal that is generated by the optical modulator are optimized. Note that output voltages of the DC power supplies 12x and 12y are not particularly limited; however, the output voltages are controlled, for example, so that their absolute values are the same and at the same time one of the voltages has a positive sign and the other has a negative sign. In this example, the DC power supply 12x outputs a negative DC voltage and the DC power supply 12y outputs a positive DC voltage.

DC electrodes 6c are formed on both sides of the DC electrode 6b so as to sandwich the DC electrode 6b therebetween. In addition, the DC electrode 6c is electrically connected to the DC electrode 6a. Therefore, a DC voltage output from the DC power supply 12x is also applied to the DC electrode 6c. Similarly, DC electrodes 6d are formed on both sides of the DC electrode 6a so as to sandwich the DC electrode 6a therebetween. In addition, the DC electrode 6d is electrically connected to the DC electrode 6b. Therefore, a DC voltage output from the DC power supply 12y is also applied to the DC electrode 6d.

As described, on the top surface of the substrate 1, the signal electrodes 3x and 3y are formed in the vicinities of the straight optical waveguides 2b and 2c, respectively. In addition, the DC electrodes 6a and 6b are formed in the vicinities of the straight optical waveguides 2b and 2c, respectively. Here, in this example, “vicinity of the optical waveguide” indicates an area that is on the top surface of the substrate 1 and that is above the optical waveguide. However, a buffer layer, etc. may be provided between the substrate 1 and the electrode.

In FIG. 5, the widths of the signal electrodes 3x and 3y and the widths of the DC electrodes 6a and 6b are greater than the widths of the straight optical waveguides 2b and 2c. However, the embodiments are not limited to this configuration. For example, the widths of the signal electrodes 3x and 3y and the widths of the DC electrodes 6a and 6b may be nearly the same as the widths of the straight optical waveguides 2b and 2c.

In the optical modulator of the above configuration, a continuous wave light that is generated by the laser light source (for example, the LD module 21 illustrated in FIG. 4) is input to the input optical waveguide 2a. The input light is branched and is guided to the straight optical waveguides 2b and 2c. The light that is propagated via the straight optical waveguides 2b and 2c is combined and is output via the output optical waveguide 2d.

When an electric signal is fed to the signal electrode 3x, an electric field is generated between the signal electrode 3x and the ground electrode 4. In addition, when an electric signal is fed to the signal electrode 3y, an electric field is generated between the signal electrode 3y and the ground electrode 4. Due to the electric fields, the refractive indexes of the straight optical waveguides 2b and 2c change, respectively. Thus, the optical modulator generates a modulated optical signal that corresponds to electric signals generated by the electric signal sources 11x and 11y.

At that time, the quality of the modulated optical signal is monitored by means of the controller (not illustrated). Output voltages of the DC power supplies 12x and 12y are controlled by the controller so that the quality of the modulated optical signal is optimized.

Note that it is assumed that the DC power supply 12x outputs −Vx and the DC power supply 12y outputs Vx. In this case, −Vx is applied to the DC electrode 6a and Vx is applied to the VC electrode 6d. Therefore, an electric field that substantially corresponds to −2Vx is generated with respect to the straight optical waveguide 2b. Similarly, Vx is applied to the DC electrode 6b and −Vx is applied to the DC electrode 6c. Therefore, an electric field that substantially corresponds to 2Vx is generated with respect to the straight optical waveguide 2c.

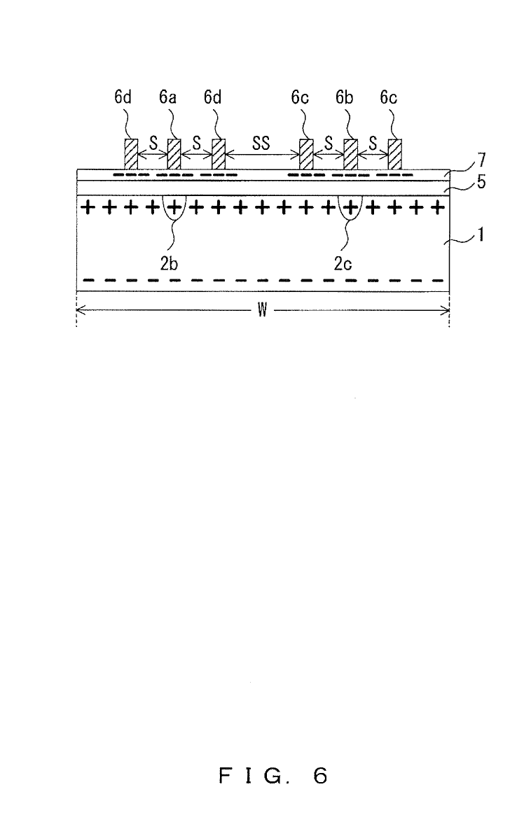

FIG. 6 is a diagram explaining uneven distribution of electric charge due to a pyroelectric effect. Note that FIG. 6 corresponds to a cross-sectional view illustrating an A-A cross section of the optical modulator illustrated in FIG. 5.

As illustrated in FIG. 6, the buffer layer 5 and a semi-conductive film 7 are formed on the top surface of the substrate 1. The buffer layer 5 is realized by an insulating film such as a SiO2 film. The semi-conductive film 7 is formed so that the resistance value between electrodes falls within a range from 10 to 100 megaohms. On the top surface of the semi-conductive film 7, the signal electrodes 3x and 3y, the ground electrodes 4, and the DC electrodes 6a-6d are formed.

Here, since the substrate 1 is a ferroelectric substrate, a pyroelectric effect is caused due to a change in temperature. In a case in which the substrate 1 is a Z-cut substrate, electric charge is concentrated in the area in the vicinity of the top surface of the substrate 1 and the area in the vicinity of the bottom surface of the substrate 1 as illustrated in FIG. 6. In the example illustrated in FIG. 6, surplus positive electric charges exist in the area in the vicinity of the top surface of the substrate 1 and surplus negative electric charges exist in the area in the vicinity of the bottom surface of the substrate 1. Furthermore, since surplus positive electric charges exist in the area in the vicinity of the top surface of the substrate 1, surplus negative electric charges exist in areas in the vicinities of each of the electrodes 6a-6d.

However, in the configuration illustrated in FIGS. 5 and 6, the widths of the electrodes 6c and 6d are narrow. Therefore, the gap between the DC electrode 6c and the DC electrode 6d (SS in FIG. 6) is wide. In addition, as illustrated in FIG. 6, DC electrodes are not formed in areas that are close to the ends of the substrate 1. That is, the ratio of the area in which the DC electrodes 6a-6d are formed is small with respect to the width W of the substrate 1.

Consequently, electric charge that is unevenly distributed in the semi-conductive film 7 due to a pyroelectric effect of the substrate 1 concentrates in areas in the vicinities of the DC electrodes 6a-6d. Furthermore, when the temperature of the optical modulator rapidly changes, the amount of electric charge increases in proportion to the temperature-change rate. Then, when the amount of electric charge that has been accumulated in the substrate 1 and in its vicinity exceeds an upper limit, the electric charge may be discharged. When the electric charge is discharged, since the electric-field distribution of the substrate 1 sharply changes, the quality of a modulated optical signal that is generated by the optical modulator deteriorates.

In view of the foregoing, the optical modulator according to the embodiments has a configuration for suppressing discharge of electric charge due to a pyroelectric effect. Some of the embodiments will be described below.

### First Embodiment

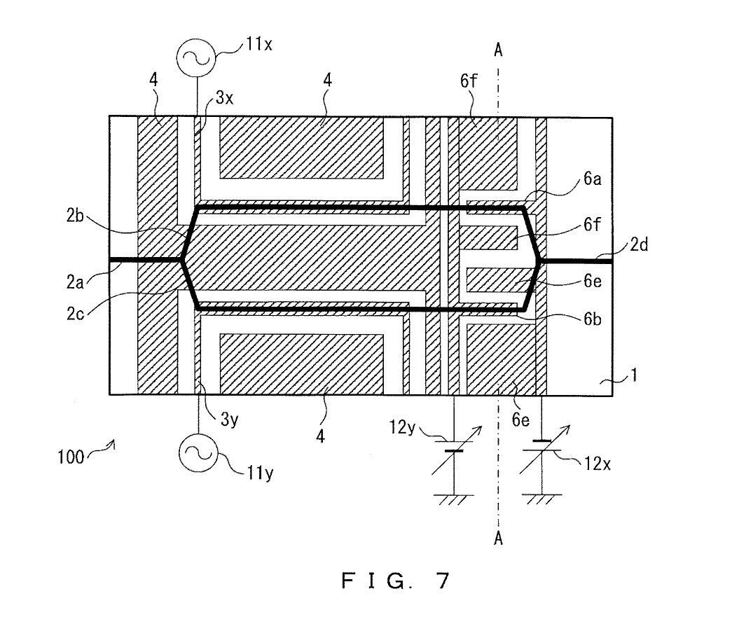

FIG. 7 illustrates the configuration of the optical modulator according to a first embodiment. An optical modulator 100 according to the first embodiment is configured by including the substrate 1 in the same manner as in the optical modulator illustrated in FIG. 5. In the substrate 1, the input optical waveguide 2a, the pair of straight optical waveguides 2b and 2c, and the output optical waveguide 2d are formed. That is, the optical waveguide that configures a Mach-Zehnder interferometer is formed in the vicinity of the top surface of the substrate 1. In the same manner as in the configuration illustrated in FIG. 6, the buffer layer 5 and the semi-conductive film 7 are formed on the top surface of the substrate 1. The signal electrodes 3x and 3y, the ground electrodes 4, and the DC electrodes 6a and 6b are formed on the semi-conductive film 7. Note that, the optical modulator 100 includes DC electrodes 6e and 6f in place of the DC electrodes 6c and 6d illustrated in FIG. 5.

The DC electrodes 6e are formed on both sides of the DC electrode 6b so as to sandwich the DC electrode 6b therebetween. In addition, the DC electrode 6e is electrically connected to the DC electrode 6a. Therefore, a DC voltage output from the DC power supply 12x is also applied to the DC electrode 6e. Similarly, the DC electrodes 6f are formed on both sides of the DC electrode 6a so as to sandwich the DC electrode 6a therebetween. In addition, the DC electrode 6f is electrically connected to the DC electrode 6b. Therefore, a DC voltage output from the DC power supply 12y is also applied to the DC electrode 6f.

As described, substantially the same voltages as those which are applied to the DC electrodes 6c and 6d illustrated in FIG. 5 are applied to the DC electrodes 6e and 6f, respectively. That is, the functions of the DC electrodes 6e and 6f are substantially the same as those of the DC electrodes 6c and 6d illustrated in FIG. 5, respectively. However, the DC electrodes 6e and 6f differ in shape from the DC electrodes 6c and 6d illustrated in FIG. 5, respectively.

Specifically, the width of the DC electrode 6e that is formed on the center side of the substrate 1 with respect to the DC electrode 6b is greater than the width of the corresponding DC electrode 6c. Similarly, the width of the DC electrode 6f that is formed on the center side of the substrate 1 with respect to the DC electrode 6a is greater than the width of the corresponding DC electrode 6d. In addition, the DC electrode 6e that is formed on the end side of the substrate 1 with respect to the DC electrode 6b extends to the end (or the vicinity of the end) of the substrate 1. Similarly, the DC electrode 6f that is formed on the end side of the substrate with respect to the DC electrode 6a extends to the end (or the vicinity of the end) of the substrate 1.

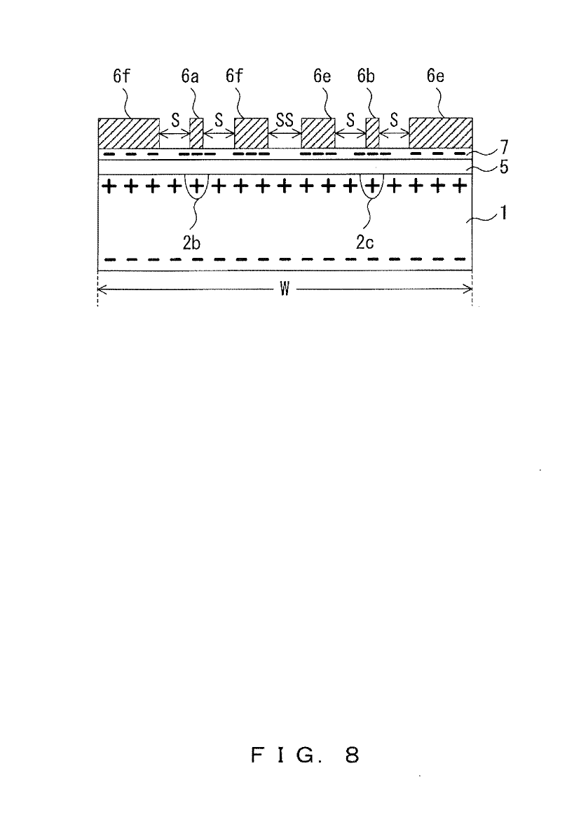

FIG. 8 is a diagram explaining effects of the first embodiment. Note that FIG. 8 corresponds to a cross-sectional view illustrating an A-A cross section of the optical modulator 100 illustrated in FIG. 7. Note that also in the optical modulator 100, in the same manner as in the optical modulator illustrated in FIG. 5, the buffer layer 5 and the semi-conductive film 7 are formed on the top surface of the substrate 1.

In the optical modulator 100, the DC electrodes 6a, 6b, 6e, and 6f are formed so that the gap SS between the DC electrode 6e and the DC electrode 6f is nearly equal to or several-times greater than the gap S between the DC electrode 6a and the DC electrode 6f (or the gap S between the DC electrode 6b and the DC electrode 6e). In addition, the DC electrode 6f that is formed on the end side of the substrate 1 with respect to the DC electrode 6a extends to the end of the substrate 1 and the DC electrode 6e that is formed on the end side of the substrate 1 with respect to the DC electrode 6b extends to the end of the substrate 1. Therefore, the percentage of the area in which the DC electrodes 6a, 6b, 6e, and 6f are formed is great with respect to the width W of the substrate 1. In other words, the percentage of the area in which the DC electrodes 6a, 6b, 6e, and 6f are not formed is small with respect to the width W of the substrate 1.

The gap S is configured to be narrow enough to efficiently apply an electric field to the corresponding straight optical waveguide 2b or 2c. For example, the gap S is 1-3 times greater than the width of the straight optical waveguides 2b and 2c. As one example, the widths of the straight optical waveguides 2b and 2c may be 7 μm and the gap S may be 15 μm. In addition, the gap SS is 1-5 times greater than the gap S. For example, when the gap S is 15 μm, the gap SS is 30 μm.

Note that the gap S may be nearly the same as the gap between the signal electrode 3x and the ground electrode 4 or the gap between the signal electrode 3y and the ground electrode 4. In this case, the gap SS between the DC electrode 6e and the DC electrode 6f may be 1-5 times greater than the gap between the signal electrode 3x and the ground electrode 4 or the gap between the signal electrode 3y and the ground electrode 4.

As described, in the optical modulator 100 according to the first embodiment, the area in which the DC electrodes (especially the DC electrodes 6e and 6f) for applying a DC voltage to the substrate 1 are formed is large. Therefore, even in a case in which electric charge is unevenly distributed in the semi-conductive film 7 due to a pyroelectric effect of the substrate 1, the electric charge does not concentrate in a narrow area. Therefore, the potential that is generated by electric charge caused by a pyroelectric effect is less likely to reach a discharge threshold. That is, since discharge due to a pyroelectric effect is suppressed and a phase jump is less likely to occur, the quality of a modulated optical signal that is generated by the optical modulator 100 is stabilized.

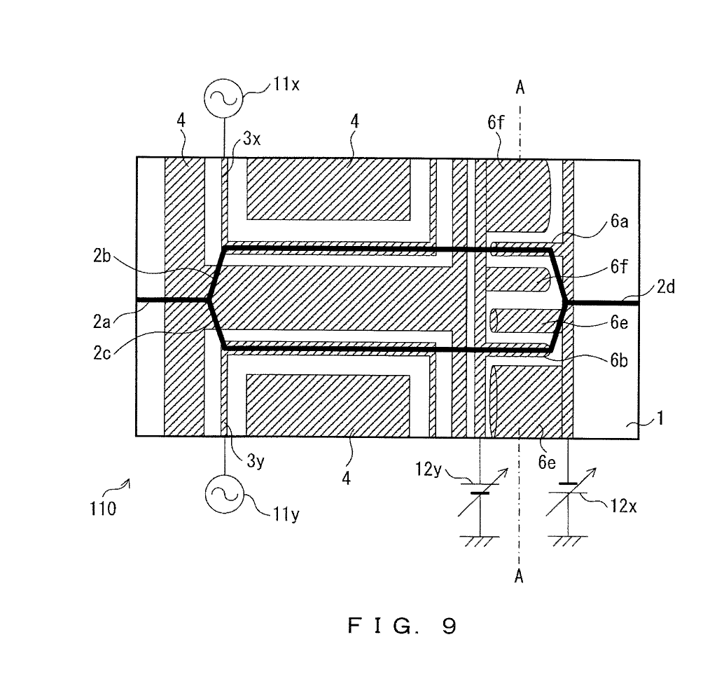

FIG. 9 illustrates a modification of the first embodiment. The configuration of an optical modulator 110 illustrated in FIG. 9 is nearly the same as that of the optical modulator 100 illustrated in FIG. 7. However, in the optical modulator 110, open ends of the DC electrodes 6a, 6b, 6e, and 6f are respectively rounded as illustrated in FIG. 9. That is, the DC electrodes 6a, 6b, 6e, and 6f are formed so that the open ends thereof do not have an acute edge. Such a configuration further suppresses the phenomenon in which electric charge is discharged from the DC electrodes.

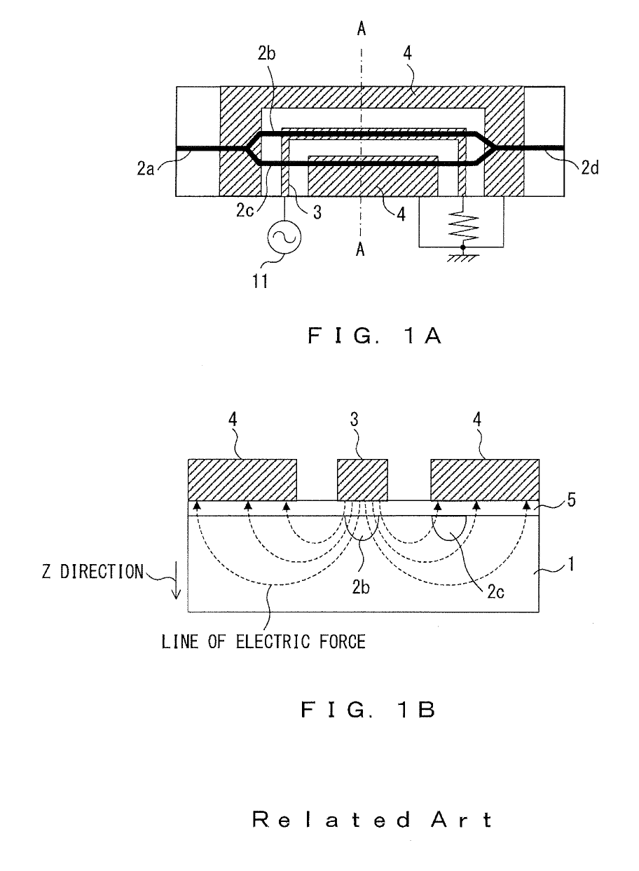

Note that in the examples illustrated in FIGS. 7 and 9, the signal electrodes 3x and 3y are formed in the vicinities of the straight optical waveguides 2b and 2c, respectively; however, the optical modulator according to the first embodiment is not limited to this configuration. That is, the optical modulator according to the first embodiment may be configured so that the signal electrode is formed in the vicinity of one of the straight optical waveguides 2b and 2c, as illustrated in FIG. 1.

### Second Embodiment

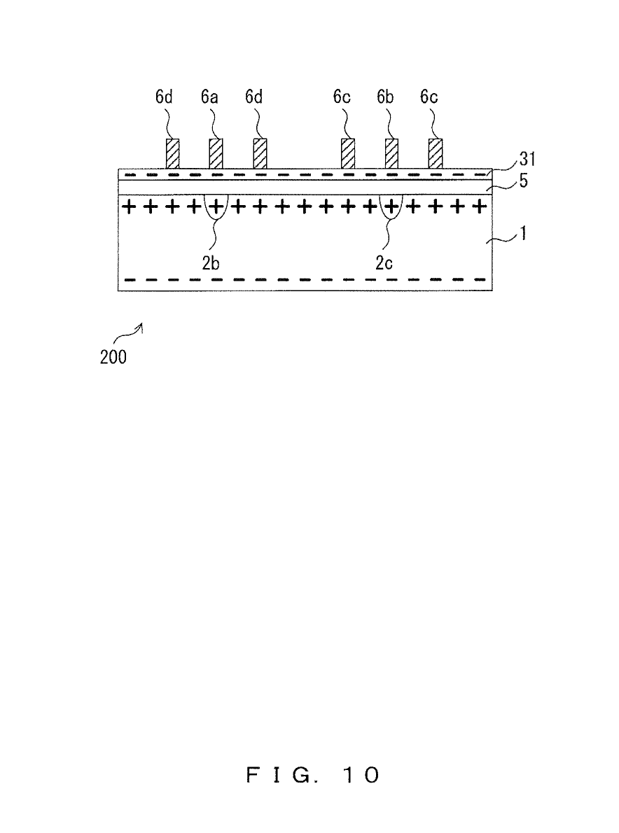

FIG. 10 illustrates the configuration of the optical modulator according to a second embodiment. The configuration of an optical modulator 200 according to the second embodiment is nearly the same as that of the optical modulator illustrated in FIGS. 5 and 6. However, resistance of a semi-conductive film 31 of the optical modulator 200 is lower than resistance of the semi-conductive film 7 illustrated in FIG. 6. For example, the semi-conductive film 31 is formed so that the resistance value between the DC electrodes 6a and 6d and the resistance value between the DC electrodes 6b and 6c are less than or equal to 1 megaohm. In addition, the semi-conductive film 31 is realized by, for example, a Si film whose resistivity is adjusted.

When the resistance of the semi-conductive film 31 is small, electric charge that is generated by a pyroelectric effect due to a change in temperature moves more easily through the semi-conductive film 31 as illustrated in FIG. 10. Therefore, a concentration of electric charge is mitigated. Therefore, the potential that is generated by electric charge caused by the pyroelectric effect is less likely to reach a discharge threshold, and discharge is suppressed.

However, when the resistance of the semi-conductive film 31 is too small, since a current flows more easily through the DC electrodes 6a-6d, it is difficult to generate an appropriate electrical field in the substrate 1. Therefore, the resistance of the semi-conductive film 31 is determined so that it is neither too large nor too small. For example, the semi-conductive film 31 is formed so that the resistance value between the DC electrodes 6a and 6d and the resistance value between the DC electrodes 6b and 6c fall within a range from 100 kiloohms to 1 megaohm.

Note that in the example illustrated in FIG. 10, the DC electrodes 6a-6d are formed on the top surface of the substrate 1; however, the second embodiment is not limited to this configuration. That is, the optical modulator 200 of the second embodiment may be configured so that the DC electrodes 6a, 6b, 6e, and 6f are formed on the top surface of the substrate 1 in the same manner as in the first embodiment.

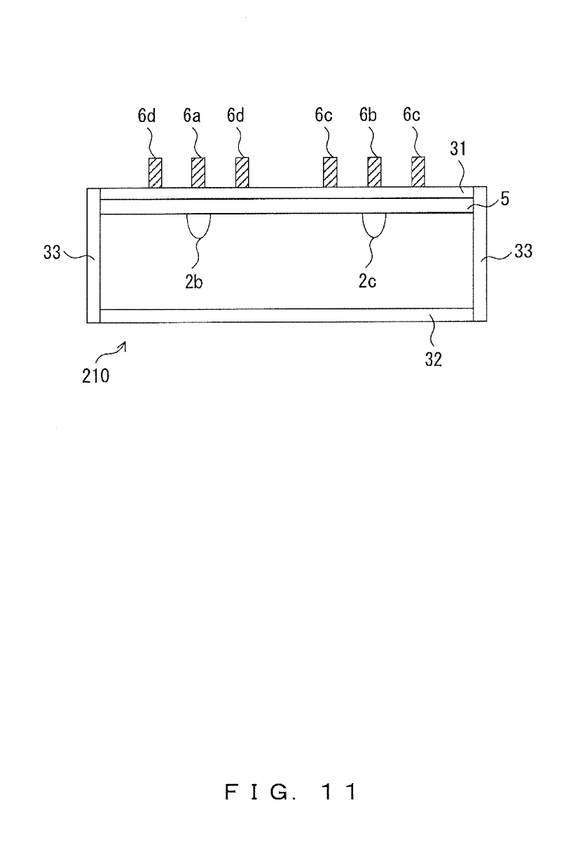

FIG. 11 illustrates a modification of the second embodiment. The configuration of an optical modulator 210 illustrated in FIG. 11 is nearly the same as that of the optical modulator 200 illustrated in FIG. 10. However, in the optical modulator 210, a semi-conductive film is formed on the bottom surface of the substrate 1 as well as on the top surface of the substrate 1. That is, a semi-conductive film 32 is formed on the bottom surface of the substrate 1. Note that the material of the semi-conductive film 31 may be the same as that of the semi-conductive film 32. In addition, a low resistance layer 33 is provided on side surfaces of the substrate 1 in order to electrically interconnect the semi-conductive film 31 and the semi-conductive film 32. The low resistance layer 33 may be realized by the same material (for example, Si) as that of the semi-conductive films 31 and 32, may be realized by another semi-conductive material, or may be realized by a metal such as Ti.

According to the configuration illustrated in FIG. 11, an area in which electric charge that is generated due to a pyroelectric effect is moved is larger in comparison with the area in the configuration illustrated in FIG. 10. Therefore, discharge due to a pyroelectric effect is further suppressed. Note that the optical modulator 210 may be configured so that the DC electrodes 6a, 6b, 6e, and 6f are formed on the top surface of the substrate 1 in the same manner as in the first embodiment.

### Third Embodiment

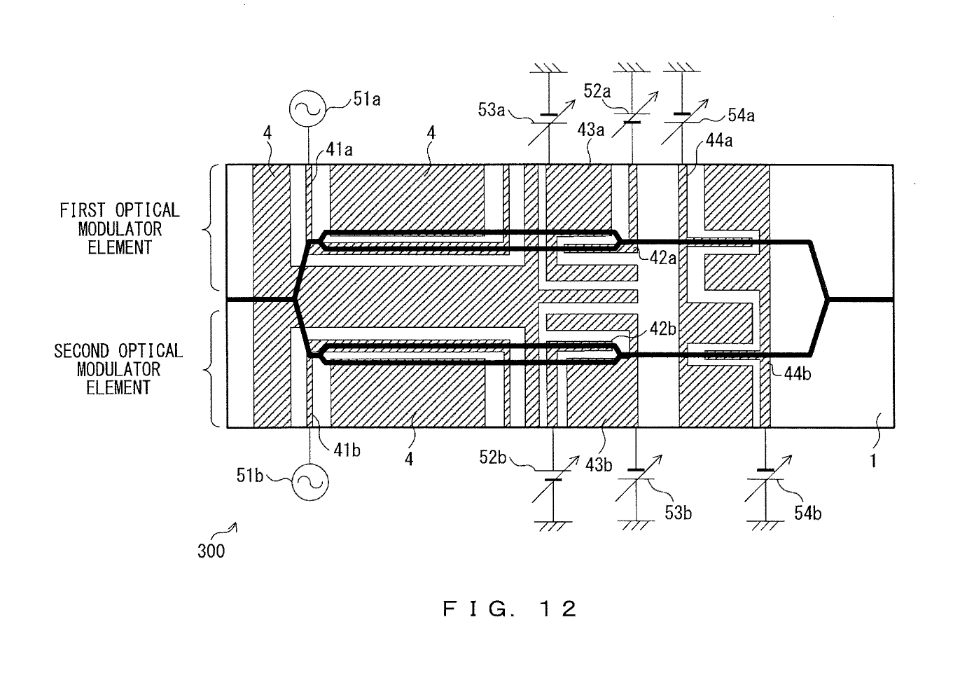

FIG. 12 illustrates the configuration of an optical modulator according to a third embodiment. An optical modulator 300 according to the third embodiment includes a pair of optical modulator elements that are provided in parallel to each other. Each optical modulator element generates a modulated optical signal. A pair of modulated optical signals that are generated by the pair of optical modulator elements are combined and output. Thus, the optical modulator 300 can generate a QPSK modulated optical signal.

In the vicinity of the top surface of the substrate 1, optical waveguides for the first optical modulator element and optical waveguides for the second optical modulator element are formed. The optical waveguides for each optical modulator element may be substantially the same as the optical waveguides 2a-2d illustrated in FIGS. 5-11. In addition, the ground electrodes 4 are formed on the top surface of the substrate 1.

In the first optical modulator element, a signal electrode 41a is formed in the vicinity of the optical waveguide. An electric signal that is generated by an electric signal source 51a is fed to the signal electrode 41a. Note that the ground electrodes 4 are formed on both sides of the signal electrode 41a. In addition, in the first optical modulator element, a DC electrode 42a and a DC electrode 43a are formed. The DC electrode 42a is formed in the vicinity of the optical waveguide. A DC voltage output from a DC power supply 52a is applied to the DC electrode 42a. The DC electrode 43a is formed on both sides of the DC electrode 42a. A DC voltage output from a DC power supply 53a is applied to the DC electrode 43a. Here, the gap between the DC electrodes 42a and 43a is formed to be, for example, about 1-3 times greater than the width of the optical waveguide.

Similarly, in the second optical modulator element, a signal electrode 41b is formed in the vicinity of the optical waveguide. An electric signal that is generated by an electric signal source 51b is fed to the signal electrode 41b. Note that the ground electrodes 4 are formed on both sides of the signal electrode 41b. In addition, in the second optical modulator element, a DC electrode 42b and a DC electrode 43b are formed. The DC electrode 42b is formed in the vicinity of the optical waveguide. A DC voltage output from a DC power supply 52b is applied to the DC electrode 42b. The DC electrode 43b is formed on both sides of the DC electrode 42b. A DC voltage output from a DC power supply 53b is applied to the DC electrode 43b. Here, the gap between the DC electrodes 42b and 43b is formed to be, for example, about 1-3 times greater than the width of the optical waveguide.

The ground electrode 4 is formed so as to extend to an area between the DC electrodes (42a, 43a) of the first optical modulator element and the DC electrodes (42b, 43b) of the second optical modulator element. That is, the DC electrodes (42a, 43a) of the first optical modulator element and the DC electrodes (42b, 43b) of the second optical modulator element are electrically separated by the ground electrode 4. In addition, the gap between the ground electrode 4 and the DC electrode 43a and the gap between the ground electrode 4 and the DC electrode 43b are formed to be about 1-5 times greater than the gap between the DC electrodes 42a and 43a (or the gap between the DC electrodes 42b and 43b). Furthermore, the DC electrode 43a and the DC electrode 43b are formed so as to reach the ends of the substrate 1. Therefore, in the third embodiment, discharge due to a pyroelectric effect is suppressed in the same manner as in the first embodiment.

Furthermore, on the top surface of the substrate 1, a DC electrode 44a for applying a DC voltage that is output from a DC power supply 54a to the optical waveguide of the first optical modulator element and a DC electrode 44b for applying a DC voltage that is output from a DC power supply 54b to the optical waveguide of the second optical modulator element are formed. Here, the DC electrodes 44a and 44b are formed so that the DC electrode 44a and the DC electrode 44b are close to each other in an area in which the DC electrode 44b is formed on both sides of the DC electrode 44a. In addition, the DC electrodes 44a and 44b are formed so that the DC electrode 44a and the DC electrode 44b are close to each other in an area in which the DC electrode 44a is formed on both sides of the DC electrode 44b.

### Fourth to Sixth Embodiments

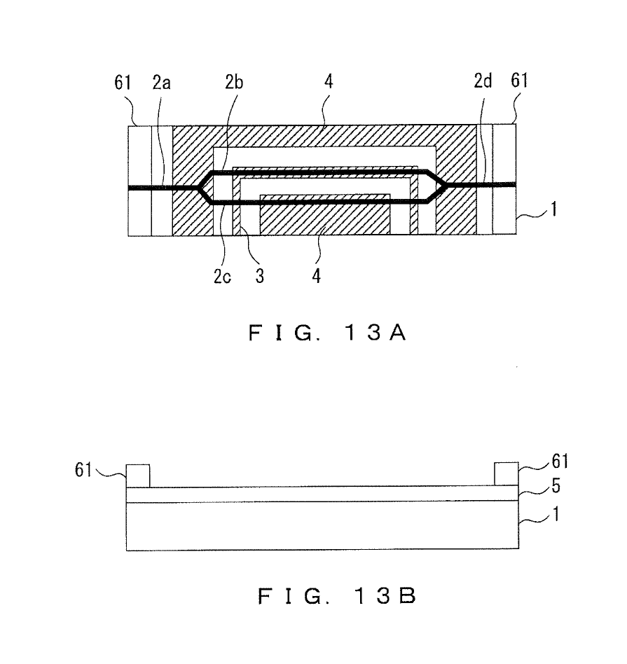

When the substrate 1 is cut out from a ferroelectric wafer by dicing, there is a risk of damaging the optical waveguide that is formed in the end of the substrate 1. Therefore, in order to protect an optical waveguide pattern that is formed in the substrate 1, a protective member is sometimes provided on the end of the substrate 1. In an example illustrated in FIGS. 13A and 13B, protective members 61 are provided on an input end and an output end of the substrate 1. The input end means the end of the substrate 1 on the side in which the input optical waveguide 2a is formed. The output end means the end of the substrate 1 on the side in which the output optical waveguide 2d of formed. Note that the protective member 61 also has the function of holding an optical fiber that is optically coupled to the optical waveguide of the optical modulator.

The protective member 61 is preferably made of a material that has the same thermal expansion coefficient as that of the substrate 1. That is, when the optical modulator is configured by including a LiNbo3 substrate, the protective member 61 is preferably made of LiNbO3. Therefore, in the following description, the protective members 61 that are provided on the input end and the output end of the substrate 1 may be referred to as ferroelectric members.

Note that, depending on the shape of the protective member 61, there is a risk of discharging from the protective member 61 electric charge that is generated by a pyroelectric effect. In view of that, optical modulators according to fourth to sixth embodiments have a configuration of suppressing discharge of electric charge that is generated due to a pyroelectric effect from the protective member 61.

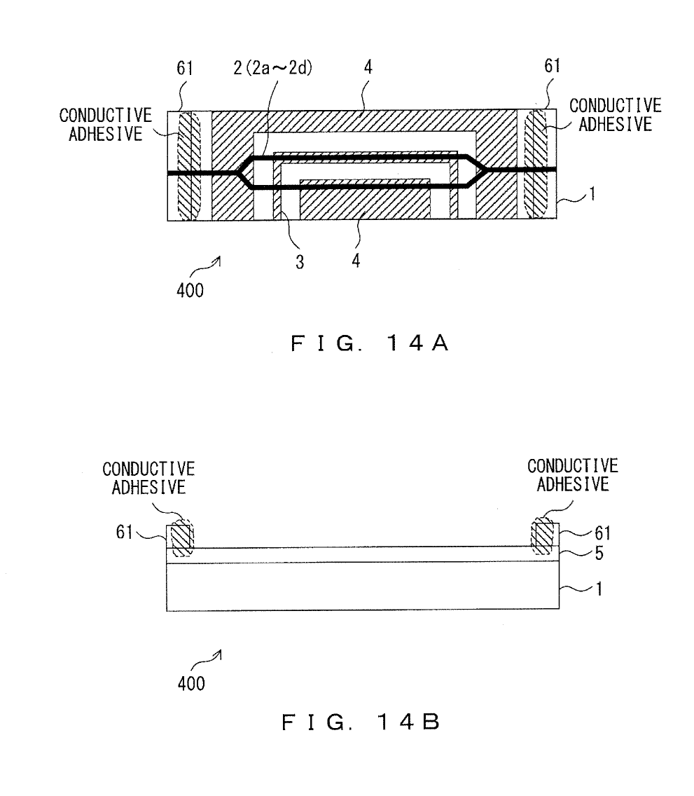

FIGS. 14A and 14B illustrate the configuration of the optical modulator according to the fourth embodiment. Note that FIG. 14A is a top view of an optical modulator 400 according to the fourth embodiment seen from above. FIG. 14B is a side view of the optical modulator 400 seen from a side. In the side view, electrodes are omitted. In addition, it is assumed that the optical waveguides, the buffer layer, the electrodes, and the protective members, which are formed on the substrate 1, in FIGS. 13A and 13B are substantially the same as those in FIGS. 14A and 14B.

In the fourth embodiment, the protective member 61 is covered with a conductive material as illustrated in FIGS. 14A and 14B. An example of the conductive material is a conductive adhesive. However, end surfaces of an optical modulator chip are configured so as not to be covered with a conductive material. Here, the end surfaces of the optical modulator mean a surface on which a continuous wave light generated by a laser light source (for example, the LD module 21 illustrated in FIG. 4) is incident, and a surface from which an optical signal generated by the optical modulator is emitted. As described, when the protective member 61 is covered with a conductive material, electric charge that is generated by a pyroelectric effect is not easily discharged from the protective member 61.

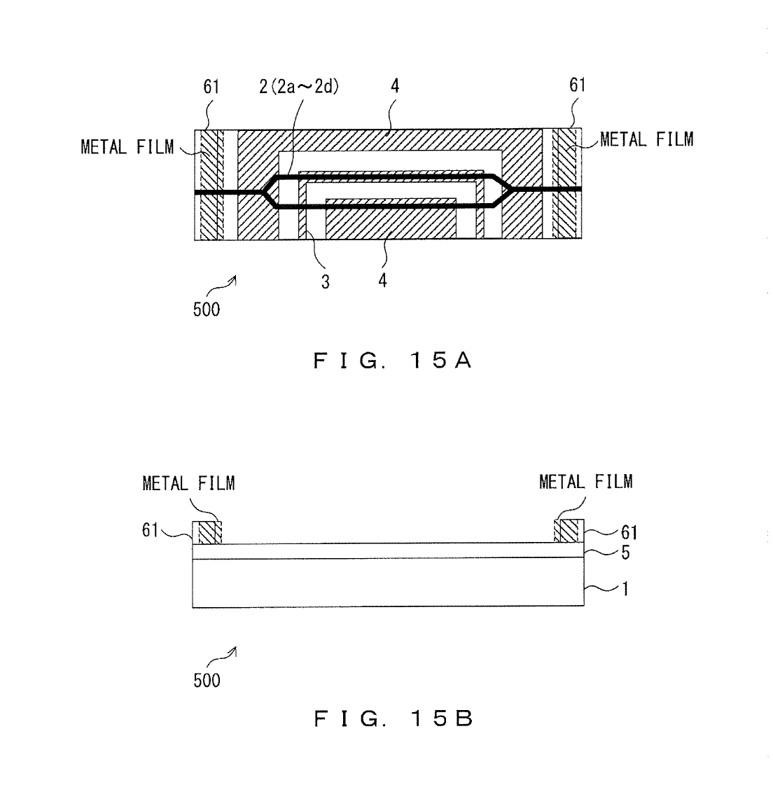

FIGS. 15A and 15B illustrate the configuration of the optical modulator according to the fifth embodiment. Note that FIG. 15A is a top view of an optical modulator 500 according to the fifth embodiment seen from above. FIG. 15B is a side view of the optical modulator 500 seen from a side. In the side view, electrodes are omitted. In addition, it is assumed that the optical waveguides, the buffer layer, the electrodes, and the protective members, which are formed on the substrate 1, in FIGS. 13A and 13B are substantially the same as those in FIGS. 15A and 15B.

In the fifth embodiment, as illustrated in FIGS. 15A and 15B, a metal film is formed on a surface of the protective member 61. Examples of the metal film include a Ni film, a Ti film, a Cu film, an Ag film, and an Au film. Alternatively, a highly conductive Si film may be formed on a surface of the protective member 61. However, the end surfaces of the optical modulator chip are configured so that neither a metal film nor a Si film is formed thereon. As described, when a metal film or a Si film is formed on the surface of the protective member 61, electric charge generated by a pyroelectric effect is not easily discharged from the protective member 61.

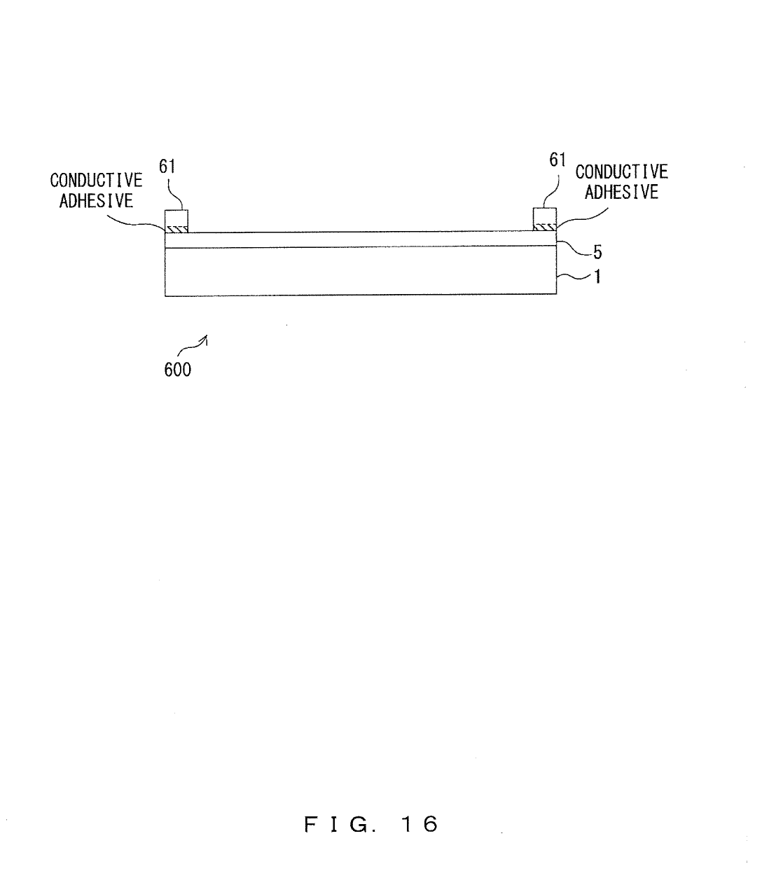

FIG. 16 illustrates the configuration of the optical modulator according to the sixth embodiment. Note that FIG. 16 is a side view of an optical modulator 600 according to the sixth embodiment seen from a side. In FIG. 16, electrodes are omitted.

In the sixth embodiment, as illustrated in FIG. 16, the protective member 61 is attached to the substrate 1 using a conductive adhesive. Also in this configuration, electric charge generated by a pyroelectric effect is not easily discharged from the protective member 61 in the same manner as in the fourth or fifth embodiment.

Note that the same effects as in the fourth to sixth embodiments will be obtained by configuring the protective member 61 by subjecting a ferroelectric material that is the same as the substrate to a reduction treatment, without forming the conductive material illustrated in FIGS. 14A and 14B, the metal film illustrated in FIGS. 15A and 15B, etc.

In addition, the same effects as in the fourth to sixth embodiments will be obtained by making the protective member 61 of, in place of a ferroelectric material, a material that does not have a pyroelectric effect and has a thermal expansion coefficient which is nearly the same as that of a ferroelectric substrate, without forming the conductive material illustrated in FIGS. 14A and 14B, the metal film illustrated in FIGS. 15A and 15B, etc.

Furthermore, the protective member 61 that is attached to the substrate 1 may not be formed of the same ferroelectric material as the substrate 1. That is, it is possible to form the protective member 61 of a material that has no pyroelectric effect and has the nearly same thermal expansion coefficient as that of the substrate 1.

### Other Embodiments

First to sixth embodiments may be arbitrarily combined to an extent that they do not contradict each other. For example, the protective member 61 may be provided on the substrate of the optical modulator 100, 110, 200, 210, or 300 according to the first to third embodiments and the configuration of the fourth, fifth, or sixth embodiment may be introduced to the protective member 61.

The substrate 1 is not limited to the Z-cut substrate (in the case of LiNbO3). For example, the configurations of the fourth to sixth embodiments are effective also in another azimuth such as an X-cut.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical modulator comprising:
a ferroelectric substrate in which an input optical waveguide, a pair of optical waveguides that are optically coupled to the input optical waveguide, and an output optical waveguide that is optically coupled to the pair of optical waveguides are formed;
a signal electrode that is formed in a vicinity of at least one of the pair of optical waveguides; and
ferroelectric members which are attached to an input end of the ferroelectric substrate in which the input optical waveguide is formed and an output end of the ferroelectric substrate in which the output optical waveguide is formed, wherein
a conductive material is in contact with the ferroelectric members.

2. The optical modulator according to claim 1, wherein
at least part of each of the ferroelectric members is covered with a conductive adhesive.

3. The optical modulator according to claim 1, wherein
at least part of each of the ferroelectric members is covered with a metal film.

4. The optical modulator according to claim 1, wherein
the ferroelectric members are attached to the ferroelectric substrate by a conductive adhesive.

5. An optical modulator comprising:
a ferroelectric substrate in which an input optical waveguide, a pair of optical waveguides that are optically coupled to the input optical waveguide, and an output optical waveguide that is optically coupled to the pair of optical waveguides are formed;
a signal electrode that is formed in a vicinity of at least one of the pair of optical waveguides; and
ferroelectric members which are attached to an input end of the ferroelectric substrate in which the input optical waveguide is formed and an output end of the ferroelectric substrate in which the output optical waveguide is formed, wherein
the ferroelectric members are subjected to a reduction treatment.

6. An optical modulator comprising:
a ferroelectric substrate in which an input optical waveguide, a pair of optical waveguides that are optically coupled to the input optical waveguide, and an output optical waveguide that is optically coupled to the pair of optical waveguides are formed;
a signal electrode that is formed in a vicinity of at least one of the pair of optical waveguides; and
member which are attached to an input end of the ferroelectric substrate in which the input optical waveguide is formed and an output end of the ferroelectric substrate in which the output optical waveguide is formed, wherein
each of the members that is attached to the ferroelectric substrate has no pyroelectric effect and is made of a material that has a thermal expansion coefficient which is equal or nearly equal to a thermal expansion coefficient of the ferroelectric substrate.
